(19) United States
(12) Patent Application Publication
(10) Pub. No.: US 2026/0110345 A1
(43) Pub. Date: Apr. 23, 2026

(54) BRAKE APPARATUS AND METHOD OF CONTROLLING THE SAME

(71) Applicant: HL MANDO CORPORATION, Pyeongtaek (KR)

(72) Inventor: Jaehyun PARK, Pyeongtaek (KR)

(21) Appl. No.: 19/083,343

(22) Filed: Mar. 18, 2025

(30) Foreign Application Priority Data
Oct. 17, 2024 (KR) 10-2024-0142273

(51) Int. Cl. F16D 65/66; B60T 1/06; B60T 8/171; B60T 8/172; B60T 13/74; F16D 65/18; F16D 65/38; F16D 121/24

(52) U.S. Cl. CPC F16D 65/66; B60T 8/171; B60T 8/172; B60T 13/746; F16D 65/18; B60T 1/065; B60T 1/067; F16D 2065/386; F16D 2121/24

(57) ABSTRACT

A brake apparatus may include a rotary member, a friction member configured to apply a frictional force to the rotary member, an electric actuator configured to move the friction member, a clamping force detection member configured to detect a clamping force in accordance with contact between the rotary member and the friction member, and a controller configured to control an operation of the electric actuator, in which the controller determines a reference position on the basis of a position of the friction member at a time point at which the rotary member and the friction member are separated, determines a clearance between the rotary member and the friction member on the basis of the detected clamping force on the basis of the reference position, and control the movement of the friction member on the basis of the clearance.

### CROSS-REFERENCE TO RELATED APPLICATIONS

This application claims the priority of Korean Patent Application No. 10-2024-0142273 filed on Oct. 17, 2024, in the Korean Intellectual Property Office, the disclosure of which is incorporated herein by reference.

### BACKGROUND

### Field

The disclosed disclosure relates to a brake apparatus and a method of controlling the same, and more particularly, to a brake apparatus, which is capable of controlling an optimal clearance of a brake based on a braking release time point, and a method of controlling the same.

### Description of the Related Art

An electromechanical brake (EMB) refers to an electronic brake apparatus that generates a braking force by generating a clamping force by means of a motor and a mechanism part without a device related to hydraulic pressure in a brake apparatus in the related art that generates a braking force by using hydraulic pressure.

It is very important for a braking system to find a predetermined clearance by performing optimal clearance control. In addition, even though the predetermined clearance is found, the braking system varies depending on the external environment because of the nature of the braking system, which may cause an inadvertent drag or affect control performance.

In the case of an electric drum brake, a drag may be generated because a drum contracts. Because there is a difference in clearance between left and right drum brakes in accordance with a temperature, a deviation between left and right braking time points may be caused, which may degrade braking stability of a vehicle.

In addition, an electric caliper brake has various hardware structures and designs to perform optimal clearance control. However, because the electric caliper brake is not a system capable of controlling the clearance in real time, a drag may be caused by external environments and temperature factors, a deviation between left and right braking time points may be caused, and the braking stability of the vehicle may be reduced.

### SUMMARY

An object to be achieved by the present disclosure is to provide a brake apparatus, which is capable of controlling an optimal clearance of a brake on the basis of a result of detecting a clamping force based on a braking release time point, and a method of controlling the same.

One aspect of the disclosed disclosure provides a brake apparatus including: a rotary member; a friction member configured to apply a frictional force to the rotary member; an electric actuator configured to move the friction member; a clamping force detection member configured to detect a clamping force in accordance with contact between the rotary member and the friction member; and a controller configured to control an operation of the electric actuator, in which the controller determines a reference position on the basis of a position of the friction member at a time point at which the rotary member and the friction member are separated, controls a movement of the friction member on the basis of the reference position, and controls an additional movement of the friction member on the basis of the detected clamping force.

The controller may determine the time point at which the rotary member and the friction member are separated by braking release on the basis of a result of comparing the detected clamping force and a reference clamping force.

The reference clamping force may include: a first reference clamping force set on the basis of a no-load state in accordance with the fastening release between the rotary member and the friction member; and a second reference clamping force made by adding a reference ascent force, which is set on the basis of a load state of the friction member, to the first reference clamping force.

The controller may move the friction member by a reference distance predetermined from the reference position when the detected clamping force is the first reference clamping force or lower.

The controller may determine the occurrence of a drag of the friction member on the basis of the result of comparing the detected clamping force and the second reference clamping force during the braking release.

When the detected clamping force is the second reference clamping force or higher, the controller may move the friction member by adding an additional distance, which is determined on the basis of the detected clamping force, to the reference distance predetermined from the reference position.

The clamping force detection member may include at least one of a force sensor configured to detect the clamping force of the friction member and an electric current sensor configured to detect an electric current applied to the electric actuator.

On the basis of at least one of the clamping force detected by the force sensor and the electric current applied to the electric actuator, the controller may determine a position of the friction member at the time point at which the friction member and the rotary member are separated, as the reference position.

When the force sensor is in an abnormal state, on the basis of the electric current applied to the electric actuator and the position information of the electric actuator, the controller may determine a position of the friction member at the time point, at which the friction member and the rotary member are separated, as the reference position.

When the clamping force detection member is in an abnormal state, the controller may move the friction member by adding a predetermined maximum additional distance to the reference distance predetermined from the reference position.

The rotary member may include a drum or disc, and the friction member may include a brake lining or a brake pad.

Another aspect of the disclosed disclosure provides a method of controlling a brake apparatus, the method including: detecting a clamping force in accordance with contact between a rotary member and a friction member of the brake apparatus; determining a reference position on the basis of a position of the friction member at a time point at which the rotary member and the friction member are separated by a braking release of the brake apparatus; determining a clearance between the rotary member and the friction member on the basis of the detected clamping force on the basis of the reference position; and controlling a movement of the friction member on the basis of the determined clearance.

The method may further include: identifying a normal operation of a clamping force detection member configured to detect the clamping force.

In the determining of the reference position, a position of the friction member at a time point, at which the rotary member and the friction member are separated by the braking release, may be determined as a reference position on the basis of a result of comparing the detected clamping force and a reference clamping force.

The reference clamping force may include: a first reference clamping force set on the basis of a no-load state in accordance with the fastening release between the rotary member and the friction member; and a second reference clamping force made by adding a reference ascent force, which is set on the basis of a load state of the friction member, to the first reference clamping force.

In the determining of the clearance, when the detected clamping force is the first reference clamping force or lower, the clearance may be determined by adding a reference distance predetermined from the reference position.

In the determining of the clearance, when the detected clamping force is the second reference clamping force or higher, the clearance of the friction member may be determined by adding an additional distance, which is determined on the basis of the detected clamping force, to the reference distance predetermined from the reference position.

In the determining of the reference position, on the basis of at least one of the clamping force detected by the force sensor and the electric current applied to the electric actuator, a position of the friction member at the time point, at which the friction member and the rotary member are separated, may be determined as the reference position.

When the force sensor is in an abnormal state, on the basis of the electric current applied to the electric actuator and the position information of the electric actuator, a position of the friction member at the time point, at which the friction member and the rotary member are separated, may be determined as the reference position.

In the determining of the clearance, when the detected clamping force is the second reference clamping force or higher, the clearance of the friction member may be determined by adding an additional distance, which is determined on the basis of the detected clamping force, to the reference distance predetermined from the reference position.

In the determining of the reference position, on the basis of at least one of the clamping force detected by the force sensor and the electric current applied to the electric actuator, a position of the friction member at the time point, at which the friction member and the rotary member are separated, may be determined as the reference position.

When the force sensor is in an abnormal state, on the basis of the electric current applied to the electric actuator and the position information of the electric actuator, a position of the friction member at the time point, at which the friction member and the rotary member are separated, may be determined as the reference position.

In the determining of the clearance, when the clamping force detection member is in an abnormal state, the clearance of the friction member may be determined by adding a predetermined maximum additional distance to the reference distance predetermined from the reference position.

According to the exemplary embodiment of the disclosed disclosure, it is possible to prevent a drag and ensure braking stability of the brake apparatus by maintaining the optimal clearance of the brake apparatus.

According to the exemplary embodiment of the disclosed disclosure, it is possible to improve fuel economy by reducing a drag and improve vehicle stability and braking response performance by reducing a left/right braking deviation.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating a brake apparatus according to the exemplary embodiment;

FIG. 2 is a view illustrating the brake apparatus according to another exemplary embodiment;

FIG. 3 is a view illustrating a control flow of the brake apparatus according to the exemplary embodiment;

FIG. 4 is a graph illustrating a change in clamping forces and a change in positions of a friction member over time in the brake apparatus according to the exemplary embodiment;

FIG. 5 is a graph illustrating a change in positions of the friction member in response to a change in clamping forces in accordance with an external environment in FIG. 4; and

FIG. 6 is a view illustrating a method of controlling the brake apparatus according to the exemplary embodiment.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Like reference numerals indicate like constituent elements throughout the specification. The present specification does not explain all the elements in the exemplary embodiments, and the general contents in the technical field to which the disclosed disclosure pertains or the contents repeatedly described in the exemplary embodiments will be omitted. The terms ‘part,’ ‘module,’ ‘member,’ ‘block’ and the like as used in the specification may be implemented in software or hardware. Further, according to the exemplary embodiments, a plurality of ‘part,’ ‘module,’ ‘member,’ ‘block’ and the like may be embodied as one component. It is also possible that one ‘part,’ ‘module,’ ‘member,’ ‘block’ and the like includes a plurality of components.

Throughout the present specification, when one constituent element is referred to as being “connected to” another constituent element, one constituent element can be “directly connected to” the other constituent element, and one constituent element can also be “indirectly connected to” the other constituent element. The indirect connection includes a connection through a wireless communication network.

In addition, unless explicitly described to the contrary, the word “comprise/include” and variations such as “comprises/includes” or “comprising/including” will be understood to imply the inclusion of stated elements, not the exclusion of any other elements.

Throughout the specification, when one member is disposed “on” another member, this includes not only a case where the one member is brought into contact with another member, but also a case where still another member is present between the two members.

The terms first, second, and the like are used to distinguish one component from another component, and the component is not limited by the terms described above.

An expression used in the singular encompasses the expression of the plural, unless it has a clearly different meaning in the context.

The reference numerals used in operations are used for descriptive convenience and are not intended to describe the order of operations and the operations may be performed in a different order unless the context clearly states a specific order.

Hereinafter, operation principles and exemplary embodiments of the disclosed disclosure will be described in detail with reference to the accompanying drawings.

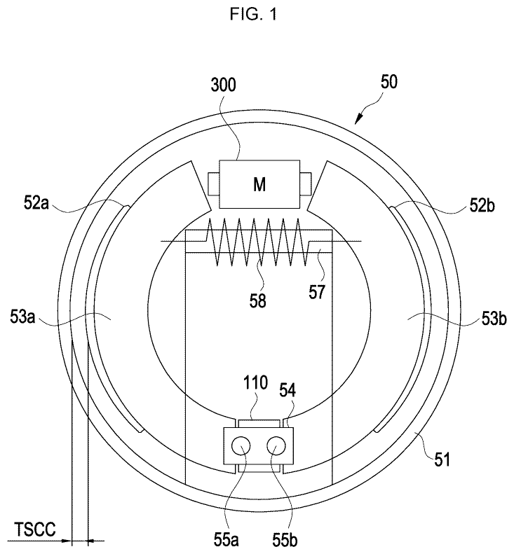

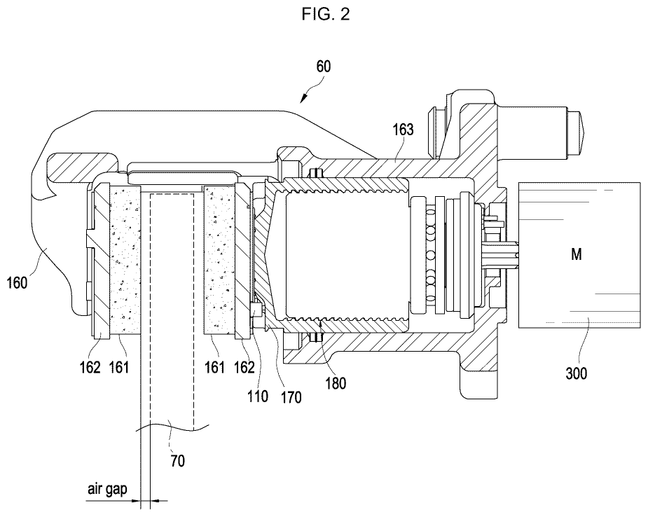

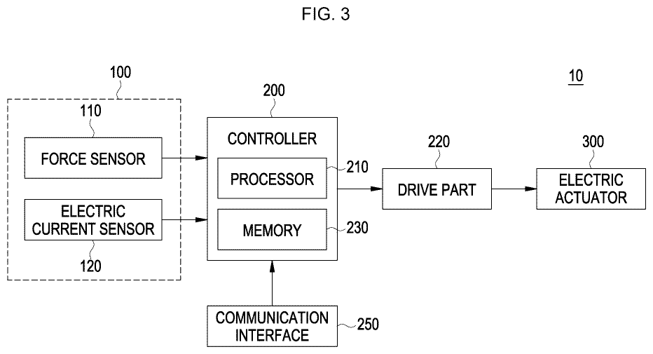

FIG. 1 is a view illustrating a brake apparatus according to the exemplary embodiment. FIG. 2 is a view illustrating the brake apparatus according to another exemplary embodiment. FIG. 3 is a view illustrating a control flow of the brake apparatus according to the exemplary embodiment.

With reference to FIGS. 1 to 3, a brake apparatus 10 may serve to brake a vehicle and include a drum 51 as a rotary member in case that the brake apparatus 10 is a drum-type brake apparatus. The brake apparatus 10 may include brake linings 52a and 52b as friction members configured to apply a frictional force to the rotary member. In addition, the brake apparatus 10 may serve to brake the vehicle and include a brake disc 70 as a rotary member in case that the brake apparatus 10 is a disc-type brake apparatus. The brake apparatus 10 may include brake pads 161 as friction members configured to apply a frictional force to the rotary member. Both the two types of brake apparatuses 10 may each include an electronic brake control module (EBCM). The brake pads may decelerate the vehicle or stop the vehicle by using friction with the brake disc 70. In addition, the brake linings 52a and 52b may decelerate the vehicle or stop the vehicle by using friction with the drum 51.

Meanwhile, in the case of the brake apparatus, clearances (pad clearances) of the brake linings 52a and 52b or the brake pads 161 may vary depending on the external environment, which may cause an inadvertent drag or degrade braking performance. For example, the drag may be caused in case that the brake apparatus 10 is thermally deformed in accordance with a temperature or in case that a clearance is not maintained because foreign substances are trapped between the rotary member and the friction member.

In order to solve the above-mentioned problems, the brake apparatus 10 controls a clearance (total shoe center clearance (TSCC)) between the brake linings 52a and 52b and the drum 51 or controls a clearance between the brake disc 70 and the brake pads 161 by using a separate mechanism part (thermo-clip or auto-adjuster). However, because the corresponding components are hardware components, precision may deteriorate, and there may occur a deviation in braking responsiveness between left and right brakes of the vehicle. In addition, the deviation in braking responsiveness may degrade the braking stability of the vehicle.

Therefore, the brake apparatus 10 according to the disclosed exemplary embodiment is intended to prevent an inadvertent vehicle operation such as a drag by adjusting an optimal clearance between the rotary member and the friction member on the basis of a detection result of a clamping force detection member 100 based on a braking release time point.

The brake apparatus 10 according to the disclosed exemplary embodiment may employ a drum brake 50 or a disc brake 60. The type of brake is not limited. Hereinafter, a drum-type brake apparatus will be described with reference to FIG. 1.

With reference to FIG. 1, the drum brake 50 may be provided to have a structure including the drum 51 configured to rotate together with a wheel, and a pair of brake shoes 53a and 53b provided in the drum 51 and attached to the brake linings 52a and 52b, in which the pair of brake shoes 53a and 53b is expanded by an electric actuator 300 so that the brake linings 52a and 52b makes friction with the drum 51. In general, the drum brake 50 is often mounted in a rear wheel of the vehicle.

The drum brake 50 may include the pair of brake shoes 53a and 53b each having an arc shape and installed to be movable along a surface of a backing plate coupled to a vehicle body, the drum 51 having a friction surface at an inner peripheral side thereof and configured to rotate together with the wheel, and the electric actuator 300 configured to apply a force to the respective brake shoes 53a and 53b in a direction in which the pair of brake shoes 53a and 53b is expanded.

The ends of the pair of brake shoes 53a and 53b, which are opposite to each other, are connected to the electric actuator 300 installed on the backing plate. The pair of brake shoes 53a and 53b may be connected to pins 55a and 55b of an anchor member 54 having one side connected to the electric actuator 300, and the other side that is opposite to one side and fixed to the backing plate. Therefore, the brake shoes 53a and 53b do not rotate together with the drum 51.

The drum brake 50 may include a strut 57 and a spring 58 provided between the pair of brake shoes 53a and 53b. The strut 57 may serve as an adjuster configured to adjust clearances between the pair of brake linings 52a and 52b and the drum 51 in accordance with abrasion of the brake linings 52a and 52b. In addition, two opposite ends of the spring 58 may be respectively coupled to the pair of brake shoes 53a and 53b, and the spring 58 may apply an elastic force to allow the pair of brake shoes 53a and 53b to become close to each other.

The electric actuator 300 may include a pressing mechanism including a motor 300, a speed reducer, and a ball-screw mechanism. When the motor 300 of the electric actuator 300 rotates in one direction, an output shaft may rotate, and the rotation may be decelerated by the speed reducer. In addition, a rotational motion, which is generated by the motor 300 of the electric actuator 300, may be converted into a rectilinear motion by the ball-screw mechanism, and the rectilinear motion may move the pair of brake shoes 53a and 53b in a direction in which the pair of brake shoes 53a and 53b moves away from each other. Therefore, the pair of brake shoes 53a and 53b, to which the brake linings 52a and 52b are attached, may generate a clamping force by pressing the drum 51. Meanwhile, when the motor 300 rotates in a reverse direction, the pair of brake shoes 53a and 53b moves in a direction in which the pair of brake shoes 53a and 53b moves toward each other. The brake linings 52a and 52b, which presses the drum 51, may be moved away from the drum 51 by the pair of brake shoes 53a and 53b, such that the clamping force may be released.

Hereinafter, the brake apparatus 10, which is an example of a disc-type brake apparatus, will be described with reference to FIG. 2.

With reference to FIG. 2, the disc brake 60 may include the brake disc 70 configured to rotate together with the wheel, a pair of pad plates 162 installed to press the brake disc 70, the pair of brake pads 161 respectively coupled to the pair of pad plates 162, a caliper housing 160 configured to accommodate the pair of pad plates 162, a piston 170 installed in the caliper housing 160 and configured to advance or retract, a power conversion unit (not illustrated) configured to receive rotational driving power for moving the piston 170, convert the rotational driving power into linear driving power, and transmit the linear driving power to the piston 170, the electric actuator 300 configured to operate as a driving source to generate rotational driving power for moving the piston 170, and a force sensor (not illustrated) configured to detect the clamping force applied to the brake disc 70 by the pair of pad plates 162 by the movement of the piston 170.

The disc brake 60 may be structured such that the pair of pad plates 162 is moved in one axial direction by the electric actuator 300 and makes friction with the brake disc 70.

The piston 170 may be provided in a cup shape opened at the rear side and slidably inserted into a cylinder. In addition, the piston 170 may press the inner pad plate 162 toward the brake disc 70 by receiving power through the power conversion unit 180.

The power conversion unit 180 may include a spindle 181 configured to rotate by receiving driving power from the motor 300, a nut 185 disposed in the piston 170, screw-connected to the spindle 181, and configured to be advanced together with the piston 170 by a rotation of the spindle 181 in a first direction or retracted together with the piston 170 by a rotation of the spindle 181 in a second direction, and a plurality of balls 189 interposed between the spindle 181 and the nut 185. The power conversion unit 180 may be provided as a ball-screw type conversion device configured to convert a rotational motion of the spindle 181 into a linear motion.

A rotational motion of the motor 300 may be converted into a linear motion of the piston 170 by the power conversion unit 180. The pair of pad plates 162 may be compressed toward the brake disc 70 by the linear motion of the piston 170, and the wheels may be braked by friction between the pair of pad plates 162 and the brake disc 70.

With reference to FIG. 3, the brake apparatus 10 may include a controller 200 configured to control an operation of the drum brake 50 or the disc brake 60 provided in at least one wheel, a drive part 220 configured to operate the electric actuator 300 of the drum brake 50 or the disc brake 60 in response to a control signal of the controller 200, the clamping force detection member 100 configured to detect the clamping force of the friction member, and a communication interface 250 configured to transmit and receive communication signals to and from various types of systems installed in the vehicle through a communication network for a vehicle.

In this case, the clamping force detection member 100 may include a force sensor 110 configured to detect the clamping force of the friction member to the rotary member, and an electric current sensor 120 configured to detect an electric current to be applied to the electric actuator 300.

The controller 200 may be referred to as an electronic control unit (ECU).

The controller 200 may include a processor 210 and a memory 230.

The controller 200 may include one or more processors 210. The one or more processors 210 included in the controller 200 may be integrated on a single chip or physically separated. In addition, the processor 210 and the memory 230 may be implemented as a single chip.

The processor 210 may control an overall operation of the brake apparatus 10.

The memory 230 may store programs and/or data for allowing the processor 210 to process data. The memory 230 may store programs and/or data for allowing the processor 210 to process data. The memory 230 may include not only volatile memories such as an S-RAM or a D-RAM, but also non-volatile memories such as a flash memory, a read-only memory (ROM) or an erasable programmable read-only memory (EPROM).

The controller 200 may perform a braking operation mode for fastening the drum brake 50 or a braking release mode for releasing the fastening of the drum brake 50 in response to an operating signal created in response to a braking manipulation of a driver.

In the braking operation mode, the controller 200 may perform a braking operation (braking apply) of generating the clamping force required to brake the vehicle by attaching the pair of brake shoes 53a and 53b, to which the brake linings 52a and 52b are attached, tightly to the drum 51 by using the electric actuator 300 of the drum brake 50. In addition, in the braking operation mode, the controller 200 may perform a braking operation of generating the clamping force required to brake the vehicle by attaching the pair of pad plates 162 tightly to the brake disc 70 by using the electric actuator 300 of the disc brake 60.

In the braking release mode, the controller 200 may perform a braking release of releasing the clamping force by spacing the pair of brake shoes 53a and 53b, to which the brake linings 52a and 52b are attached, from the drum 51 by using the electric actuator 300 of the drum brake 50. In addition, in the braking release mode, the controller 200 may perform a braking release of releasing the clamping force by spacing the pair of pad plates 162 from the brake disc 70 by using the electric actuator 300 of the disc brake 60.

In the braking operation mode, the controller 200 may rotate the motor 300 in one direction until the clamping force detected by the force sensor 110 reaches a target clamping force required to brake the vehicle. Meanwhile, in the braking release mode, the controller 200 may rotate the motor 300 in the reverse direction until the clamping force detected by the force sensor 110 reaches a clamping force critical value or less.

In this case, the force sensor 110 may be disposed between the pair of brake shoes 53a and 53b in the drum brake 50 and detect the clamping force generated by the movements of the brake shoes 53a and 53b. Alternatively, the force sensor 110 may be disposed between the piston 170 and the pad plate 162 in the disc brake 60 and detect the clamping force generated by the movement of the piston 170.

In the braking operation mode, the controller 200 rotates the motor 300 in one direction until an electric current value of the motor 300 of the electric actuator 300 reaches a target electric current value corresponding to the clamping force required to brake the vehicle. Meanwhile, in the braking release mode, the controller 200 rotates the motor 300 in the reverse direction until the electric current of the motor 300 reaches a target electric current value corresponding to the braking release.

In response to the control signal of the controller 200, the drive part 220 may rotate the motor 300 forward or reversely. For example, in order to rotate the motor 300 forward or reversely, the drive part 220 may include an H-bridge circuit including a plurality of electric power switching elements.

During the braking operation in which the motor 300 is rotated in one direction by the drive part 220, the rotation of the motor 300 in one direction is decelerated by the speed reducer, and a high force rectilinearly moves the ball-screw mechanism to allow the pair of brake shoes 53a and 53b, to which the brake linings 52a and 52b are attached, to press the drum 51, thereby braking the wheels. The braking release may be performed in the opposite way to the braking operation.

In addition, during the braking operation in which the motor 300 is rotated in one direction by the drive part 220, the rotation of the motor 300 in one direction rectilinearly moves the piston 170 by means of the power conversion unit to allow the pair of pad plates 162, which includes the brake pads, to press the brake disc 70, thereby braking the wheels. The braking release may be performed in the opposite way to the braking operation.

The controller 200 may receive the electric current of the motor 300 detected by the electric current sensor 120 and receive the clamping force detected by the force sensor 110. On the basis of the electric current detected by the electric current sensor 120 and the clamping force detected by the force sensor 110, the controller 200 may determine a reference position that is a position of the friction member at a time point at which the brake linings 52a and 52b, which are the friction members, and the drum 51, which is the rotary member, are separated during the braking release. A specific description thereof will be described below.

The controller 200 may receive various types of vehicle states, such as a brake pedal state, gear shift information, wheel speed information, and braking pressure information, from various types of systems through the communication interface 250.

On the basis of the information inputted through the communication interface 250, the controller 200 may determine a braking operation request for fastening the drum brake 50 or a braking release request for releasing the fastening of the drum brake 50.

As described above, in the case of the drum brake 50, the clearance between the drum 51 and the brake linings 52a and 52b may vary depending on the external environment. In addition, in the case of the disc brake 60, the clearance between the brake disc 70 and the brake pad 161 may vary depending on the external environment. For example, because a temperature decreases after the braking-fastening operation is performed at a high temperature, the thermally expanded drum 51 may be thermally contracted, which may increase a fastening force. When the braking-fastening release operation is performed by the drum brake 50 in a state in which a temperature is not sufficiently decreased, a drag of the vehicle may be caused by the thermal contraction of the drum 51. In addition, when the braking-fastening release operation is performed by the drum brake 50 in a state in which foreign substances are trapped between the drum 51 and the brake linings 52a and 52b, a drag may occur because a load is generated by the foreign substances even though the brake linings 52a and 52b move to target positions.

When a braking request is received by the driver's manipulation or the like while the vehicle travels, the controller 200 of the brake apparatus 10 may generate the clamping force by controlling the electric actuator 300, as described above. When the braking release is required as the braking request is removed after the clamping force is generated, the controller 200, likewise, may control the electric actuator 300 to separate the brake linings 52a and 52b or the brake pads 161, which are the friction members, from the drum 51 or the brake disc 70 that is the rotary member, thereby releasing the braked state.

In order to determine the clearance between the friction member and the rotary member during the braking release, the controller 200 according to the disclosed exemplary embodiment may detect a change in clamping forces in accordance with the braking-fastening release between the rotary member and the friction member. Further, on the basis of the result of detecting the clamping force, the controller 200 may determine the clearance between the rotary member and the friction member and control the movement of the position of the friction member in accordance with the determined clearance, thereby preventing a drag of the friction member.

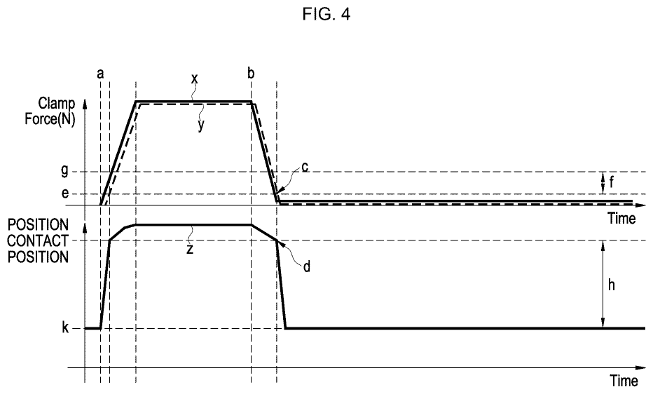

FIG. 4 illustrates a target clamping force and a detected clamping force for braking-fastening and braking-fastening release of the brake apparatus in a normal state and illustrates a target position of the friction member for controlling the clearance with the rotary member on the basis of a detection value of the clamping force.

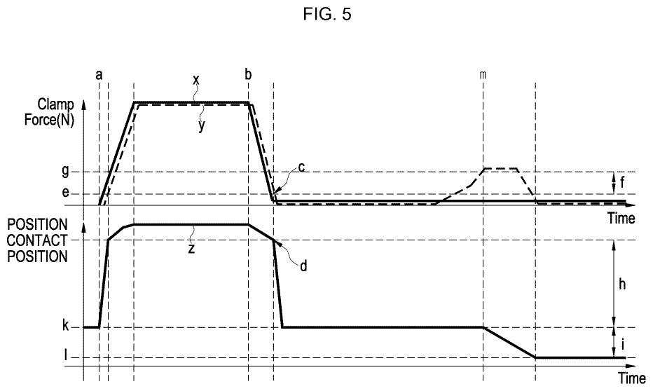

FIG. 5 illustrates a target clamping force and a detected clamping force for braking-fastening and braking-fastening release of the brake apparatus in a drag generation state and illustrates a first target position and a second target position of the friction member for controlling the clearance with the rotary member on the basis of the detected clamping force.

With reference to FIG. 4, the controller 200 may perform control so that a detected clamping force y of the friction member to the rotary member ascends while following a target clamping force x from a braking force request time point a by the driver's manipulation on a brake pedal. When the target clamping force x is reached, the controller 200 maintains the detected clamping force y.

In addition, the controller 200 may perform control so that the detected clamping force y descends while following the target clamping force x from a time point b at which a braking force release request is inputted by the driver's manipulation on the brake pedal. When the detected clamping force y reaches a predetermined first reference clamping force e, the controller 200 may determine the corresponding time point as a fastening release time point c at which the friction member and the rotary member are separated.

The controller 200 may determine the position of the friction member at the fastening release time point c as a reference position d. The controller 200 may determine a distance, which is made by adding a predetermined reference distance h to the reference position d set as a zero point, as the clearance between the friction member and the rotary member, such that the friction member may be spaced apart from the rotary member by the reference distance h. That is, as illustrated in FIG. 3, in the general state, the controller 200 may move the friction member to a first target position k spaced apart, by the reference distance h, from the reference position d at which the friction member and the rotary member are separated during the braking release. The first target position k may be set to a spacing position of the friction member with respect to the rotary member. In this case, the reference distance h may have a value within a range of about 0.3 to 0.8 mm in the case of the drum brake, and the reference distance h may have a value within a range of about 0.2 to 0.3 mm in the case of the disc brake.

When the result of detecting the clamping force indicates that the clamping force decreases to the first reference clamping force e or less, the controller 200 may store the reference position d and the detected clamping force y of the friction member. In this case, the first reference clamping force e refers to a clamping force set in consideration of a sensor offset and/or apparatus properties in a no-load state to determine the fastening release between the rotary member and the friction member. For example, the first reference clamping force e may be set to about 100 N.

With reference to FIG. 5, the controller 200 may determine the occurrence of a drag when the detected clamping force y ascends to a second reference clamping force g or more after the fastening release time point c. In this case, the second reference clamping force g may be set by adding a predetermined reference ascent force f to the first reference clamping force e to determine the occurrence of a drag. The reference ascent force f may be set in consideration of a sensor offset and/or apparatus properties based on a load state to determine the occurrence of a drag of the friction member. For example, the reference ascent force f may be set to about 300 N or more to determine the occurrence of an inadvertent drag.

When a drag occurs, the controller 200 determines the clearance between the friction member and the rotary member by adding an additional distance i to the distance made by adding the predetermined reference distance h to the reference position d set as a zero point, and the controller 200 may space the friction member from the rotary member in accordance with the determined clearance by a distance made by adding up the reference distance h and the additional distance i. That is, as illustrated in FIG. 4, the controller 200 may move the friction member to a second target position l made by adding the additional distance i to the first target position k spaced apart, by the reference distance h, from the reference position d at which the friction member and the rotary member are separated during the braking release. The first target position k may be set to the existing spacing position of the friction member with respect to the rotary member, and the second target position l may be set to a new spacing position with respect to the rotary member.

The additional distance i is a value that may be variably changed in accordance with the detected clamping force y in case that the detected clamping force y is higher than the second reference clamping force g, and the additional distance i may have a larger value as the detected clamping force y is higher than the second reference clamping force g. For example, the additional distance i may have a value within a range of about 0.1 to 0.2 mm.

That is, in case that the detected clamping force y is higher than the second reference clamping force g (m) after the fastening release time point c, the controller 200 may determine that a drag occurs on the friction member by the external environment, and the controller 200 may prevent a drag of the friction member by spacing the friction member from the rotary member by adding the additional distance i to the reference distance h.

The controller 200 monitors an operating state of the clamping force detection member 100 by means of the communication with the clamping force detection member 100. In case that the clamping force detection member 100 is normal, the controller 200 may space the friction member from the rotary member by the reference distance h by determining the distance, which is made by adding the predetermined reference distance h to the reference position d, as the clearance between the friction member and the rotary member during the braking release. In case that the clamping force detection member 100 is abnormal, the controller 200 may space the friction member from the rotary member by the clearance made by adding a maximum value of the additional distance i to the reference distance h predetermined from the reference position d during the braking release.

For example, in case that the force sensor 110 fails, the controller 200 may enter a failure mode and maximally increase the clearance between the friction member and the rotary member by moving the friction member by the clearance made by adding a maximum value of the additional distance i to the reference distance h so that a drag does not occur under all conditions.

Meanwhile, in case that the force sensor 110 fails and the electric current sensor 120 is normal, the controller 200 may enter a fallback mode, measure the electric current, which is applied to the electric actuator 300, by using the electric current sensor 120, estimate the clamping force by using the measured electric current, and control the clearance between the friction member and the rotary member on the basis of the clamping force.

In this case, on the basis of the electric current applied to the motor 300 and the position information of the motor 300, the controller 200 may determine the position of the friction member at the time point, at which the friction member and the rotary member are separated, as the reference position d. For example, the controller 200 may estimate a time point, at which the electric current measured by the electric current sensor 120 exceeds a predetermined reference current, as a braking-fastening time, and estimate a time point, at which the electric current decreases to a reference current or less, as the fastening release time point c. In addition, the controller 200 may determine a position of the friction member at the estimated fastening release time point c as the reference position d and determine the distance, which is made by adding the predetermined reference distance h to the determined reference position d set as the zero point, as the clearance between the friction member and the rotary member, and the controller 200 may space the friction member from the rotary member by the reference distance h.

The controller 200 may estimate the clamping force by using the electric current in the same way as the method of controlling the clearance between the friction member and the rotary member by using the detected clamping force y, and the controller 200 may control the clearance between the friction member and the rotary member on the basis of the estimated clamping force.

According to the disclosed exemplary embodiment, it is possible to monitor and control, in real time, the clearance between the rotary member and the friction member by means of the optimal clearance control based on the force sensor.

In addition, according to the disclosed exemplary embodiment, the control performance of the vehicle may be improved, and the constant control performance may be maintained.

In addition, according to the disclosed exemplary embodiment, it is possible to improve fuel economy of the vehicle by reducing the occurrence of a drag and improve vehicle stability by reducing a left/right braking deviation.

In addition, according to the disclosed exemplary embodiment, it is possible to improve the braking response performance by reducing a braking responsiveness deviation.

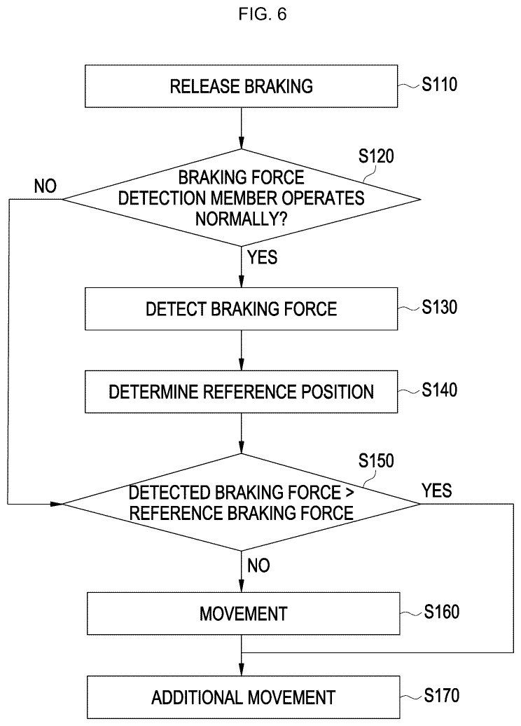

FIG. 6 is a view illustrating a method of controlling the brake apparatus according to the exemplary embodiment.

Hereinafter, a control method performed by the brake apparatus in FIGS. 1 to 3 will be described.

With reference to FIG. 6, the method may include step S110 of inputting the braking release request by the driver's manipulation on the brake pedal, step S120 of identifying a normal operation of the clamping force detection member configured to detect the clamping force, step S130 of detecting the clamping force in accordance with the contact between the rotary member and the friction member, step S140 of determining the reference position on the basis of the position of the friction member at the time point at which the rotary member and the friction member are separated by the braking release, step S150 of comparing the detected clamping force and the reference clamping force during the braking release, step S160 of controlling the movement of the friction member on the basis of the reference position, and step S170 of controlling the additional movement of the friction member on the basis of the detected clamping force.

In step S110, the controller may receive the braking release request made by the driver's manipulation on the brake pedal.

In step S120, the controller may communicate with the clamping force detection member configured to detect the clamping force and identify the normal operation of the clamping force detection member. If the clamping force detection member is in an abnormal state, the controller may go to step S162 and determine the clearance between the rotary member and the friction member by adding the predetermined reference distance and the maximum additional distance to the reference position, and the controller may move the friction member by controlling the electric actuator on the basis of the determined clearance.

In step S130, the clamping force detection member may detect the clamping force in accordance with the contact between the rotary member and the friction member.

In step S140, on the basis of the result of comparing the detected clamping force and the reference clamping force, the controller may determine the position of the friction member at the time point at which the rotary member and the friction member are separated by the braking release, as the reference position. The reference clamping force may include a first reference clamping force, which is set on the basis of a no-load state in accordance with the fastening release between the rotary member and the friction member, and a second reference clamping force made by adding a reference ascent force, which is set on the basis of a load state of the friction member, to the first reference clamping force.

When the detected clamping force is the first reference clamping force or lower, the controller may determine the position of the friction member at the time point at which the rotary member and the friction member are separated, as the reference position.

In step S150, the occurrence of a drag may be detected by comparing the second reference clamping force and the detected clamping force in the braking release state. If the detected clamping force is the second reference clamping force or lower, the controller may go to step S160 and perform the subsequent process.

In step S160, on the basis of the result of comparing the detected clamping force and the reference clamping force, the controller may control the movement of the friction member based on the reference position. In this case, when the detected clamping force is the first reference clamping force or lower, the controller may determine the clearance between the rotary member and the friction member by adding the predetermined reference distance to the reference position and move the friction member by controlling the electric actuator on the basis of the determined clearance.

In step S170, during the fastening release, the controller may control the additional movement of the friction member on the basis of the result of comparing the detected clamping force and the reference clamping force. In this case, when the detected clamping force is the second reference clamping force or higher, the controller may determine the clearance between the rotary member and the friction member by adding the additional distance to the predetermined reference distance from the reference position and move the friction member by controlling the electric actuator on the basis of the determined clearance.

If the detected clamping force is the second reference clamping force or lower during the fastening release, the controller determines that a drag does not occur, and the controller does not additionally move the friction member.

On the other hand, the disclosed exemplary embodiments may be implemented in the form of a recording medium that stores computer-executable instructions. The instruction may be stored in the form of a program code. When the instruction is executed by a processor, a program module may be generated, and operations of the disclosed exemplary embodiments may be performed. The recording medium may be implemented as a computer-readable recording medium.

Examples of the computer-readable recording medium include all kinds of recording media for storing instructions readable by a computer. Specific examples thereof may include a read only memory (ROM), a random access memory (RAM), a magnetic tape, a magnetic disc, a flash memory, an optical data storage device, and the like.

The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium. For example, a “non-transitory storage medium” may include a buffer that temporarily stores data.

As described above, the exemplary embodiments have been described with reference to the accompanying drawings. A person skilled in the art may understand that the present disclosure may be carried out in other forms different from those disclosed in the exemplary embodiments without changing the technical spirit or the essential features of the present disclosure. The disclosed exemplary embodiments are illustrative and should not be interpreted as being restrictive.

What is claimed is:

1. A brake apparatus comprising:
a rotary member;
a friction member configured to apply a frictional force to the rotary member;
an electric actuator configured to move the friction member;
a clamping force detection member configured to detect a clamping force in accordance with contact between the rotary member and the friction member; and
a controller configured to control an operation of the electric actuator,
wherein the controller determines a reference position on the basis of a position of the friction member at a time point at which the rotary member and the friction member are separated, controls a movement of the friction member on the basis of the reference position, and controls an additional movement of the friction member on the basis of the detected clamping force.

2. The brake apparatus of claim 1, wherein the controller determines the time point at which the rotary member and the friction member are separated by a braking release on the basis of a result of comparing the detected clamping force and a reference clamping force.

3. The brake apparatus of claim 2, wherein the reference clamping force includes:
a first reference clamping force set on the basis of a no-load state in accordance with a fastening release between the rotary member and the friction member; and
a second reference clamping force made by adding a reference ascent force, which is set on the basis of a load state of the friction member, to the first reference clamping force.

4. The brake apparatus of claim 3, wherein the controller moves the friction member by a reference distance predetermined from the reference position when the detected clamping force is the first reference clamping force or lower.

5. The brake apparatus of claim 3, wherein the controller determines occurrence of a drag of the friction member on the basis of a result of comparing the detected clamping force and the second reference clamping force during the braking release.

6. The brake apparatus of claim 5, wherein when the detected clamping force is the second reference clamping force or higher, the controller moves the friction member by adding an additional distance, which is determined on the basis of the detected clamping force, to a reference distance predetermined from the reference position.

7. The brake apparatus of claim 1, wherein the clamping force detection member includes at least one of a force sensor configured to detect the clamping force of the friction member and an electric current sensor configured to detect an electric current applied to the electric actuator.

8. The brake apparatus of claim 7, wherein on the basis of at least one of the clamping force detected by the force sensor and the electric current applied to the electric actuator, the controller determines the position of the friction member at the time point at which the friction member and the rotary member are separated, as the reference position.

9. The brake apparatus of claim 7, wherein when the force sensor is in an abnormal state, on the basis of the electric current applied to the electric actuator and position information of the electric actuator, the controller determines the position of the friction member at the time point, at which the friction member and the rotary member are separated, as the reference position.

10. The brake apparatus of claim 7, wherein when the clamping force detection member is in an abnormal state, the controller moves the friction member by adding a predetermined maximum additional distance to a reference distance predetermined from the reference position.

11. The brake apparatus of claim 1, wherein the rotary member includes a drum or disc, and the friction member includes a brake lining or brake pad.

12. A method of controlling a brake apparatus, the method comprising:
detecting a clamping force in accordance with contact between a rotary member and a friction member of the brake apparatus;
determining a reference position on the basis of a position of the friction member at a time point at which the rotary member and the friction member are separated by a braking release of the brake apparatus;
controlling a movement of the friction member on the basis of the reference position; and
controlling an additional movement of the friction member on the basis of the detected clamping force.

13. The method of claim 12, further comprising:
identifying a normal operation of a clamping force detection member configured to detect the clamping force.

14. The method of claim 12, wherein in the determining of the reference position, the position of the friction member at a time point, at which the rotary member and the friction member are separated by the braking release, is determined as the reference position on the basis of a result of comparing the detected clamping force and a reference clamping force.

15. The method of claim 14, wherein the reference clamping force includes:
a first reference clamping force set on the basis of a no-load state in accordance with a fastening release between the rotary member and the friction member; and
a second reference clamping force made by adding a reference ascent force, which is set on the basis of a load state of the friction member, to the first reference clamping force.

16. The method of claim 15, wherein in the controlling of the movement of the friction member, the friction member is moved by a reference distance predetermined from the reference position when the detected clamping force is the first reference clamping force or lower.

17. The method of claim 15, wherein in the controlling of the additional movement of the friction member, when the detected clamping force is the second reference clamping force or higher during a fastening release, the friction member is additionally moved by adding an additional distance, which is determined on the basis of the detected clamping force, to a reference distance predetermined from the reference position.

18. The method of claim 12, wherein in the determining of the reference position, on the basis of at least one of the clamping force detected by a force sensor and an electric current applied to an electric actuator, the position of the friction member at the time point, at which the friction member and the rotary member are separated, is determined as the reference position.

19. The method of claim 18, wherein when the force sensor is in an abnormal state, on the basis of the electric current applied to the electric actuator and position information of the electric actuator, the position of the friction member at the time point, at which the friction member and the rotary member are separated, is determined as the reference position.

20. The method of claim 18, wherein in the controlling of the movement of the friction member, when the clamping force detection member is in an abnormal state, the movement of the friction member is controlled by adding a predetermined maximum additional distance to a reference distance predetermined from the reference position.
